(19) United States
(12) Patent Application Publication
(10) Pub. No.: US 2024/0170640 A1
(43) Pub. Date: May 23, 2024

(54) METHOD OF FORMING A BATTERY ELECTRODE MICROSTRUCTURE TO REDUCE TORTUOSITY

(71) Applicant: Ford Motor Company, Dearborn, MI (US)

(72) Inventors: Paul John Bojanowski, Macomb Township, MI (US); Gary Thomas Martini, Dexter, MI (US)

(73) Assignee: Ford Motor Company, Dearborn, MI (US)

(21) Appl. No.: 17/990,914

(22) Filed: Nov. 21, 2022

(51) Int. Cl. H01M 4/04; H01M 4/583; H01M 4/62

(52) U.S. Cl. CPC H01M 4/0485; H01M 4/0471; H01M 4/583; H01M 4/623

(57) ABSTRACT

A method of manufacturing a battery electrode includes casting a solid battery electrode from a slurry including electrode particles, a binder, and a solvent, wherein residual solvent remains after the casting and the binder remains at least partially elastic. The solid battery electrode then undergoes flash-freezing such that the residual solvent forms dendritic ice having a pattern, and then the dendritic ice is removed from the solid battery electrode, thereby rearranging the electrode particles and the binder into a microstructure that represents a geometric negative of the pattern of the dendritic ice.

### FIELD

The present disclosure relates to battery electrodes, and more specifically to the structure of a battery electrode for improved battery performance and more efficient manufacturing.

### BACKGROUND

The statements in this section merely provide background information related to the present disclosure and may not constitute prior art.

During the manufacture of battery electrodes or fuel cells, residual water within the structure of the electrode, either from the initial coating and drying process or humidity sorption from the environment, is removed later in a vacuum drying process or additional long convection drying process before assembly. This drying process is separate from upstream and downstream battery assembly processes and is also relatively slow (about 6-24 hours), as well as energy intensive. The slow drying rate is governed by diffusion transport mechanisms of the phase change from liquid to vapor within the electrode. As a result, manufacturing battery electrodes is time consuming and relatively inefficient within the battery assembly process.

These issues with the manufacture of battery electrodes are addressed by the present disclosure.

### SUMMARY

This section provides a general summary of the disclosure and is not a comprehensive disclosure of its full scope or all of its features.

In one form, a method of manufacturing a battery electrode comprises casting a solid battery electrode from a slurry including electrode particles, a binder, and a solvent, wherein residual solvent remains after the casting and the binder remains at least partially elastic. Next, the solid battery electrode undergoes flash-freezing such that the residual solvent forms dendritic ice having a pattern. Subsequently, the dendritic ice is removed from the solid battery electrode, thereby rearranging the electrode particles and the binder into a microstructure that represents a geometric negative of the pattern of the dendritic ice.

In variations of this method, which may be implemented individually or in any combination: the dendritic ice is removed by drying; a temperature and pressure during the flash-freezing and the drying are adjusted to modify the microstructure; the dendritic ice is removed by vacuum drying; the flash-freezing and the vacuum drying are performed in an inert gas environment; the electrode particles comprise graphite; the binder is selected from the group consisting of fluoro acrylic polymer, poly tetrafluoro ethylene, poly vinylidene fluoride, poly acrylates, aliphatic polymers, aromatic polymers, oligo- and polysaccharides chitosan, alginate, pectin, amylose, starch, gums, lignin, and proteins; and the solvent is selected from the group consisting of H₂O (Water), NMP (N-Methyl-2-pyrrolidone), DMF (Dimethylformamide), DMAC (Dimethylacetamide), and DMSO (Dimethyl sulfoxide).

In another form of the present disclosure, a method of manufacturing an electrode comprises casting a solid battery electrode from a slurry including electrode particles, a binder, and a solvent, wherein residual solvent remains after the casting and the binder remains at least partially elastic. The solid battery electrode then undergoes flash-freezing in an inert gas environment in a vacuum such that the residual solvent in the electrode forms dendritic ice having a pattern. Subsequently, the dendritic ice is removed from the solid battery electrode by vacuum drying, thereby rearranging the electrode particles and the binder into a microstructure that represents a geometric negative of the pattern of the dendritic ice.

In variations of this method, which may be implemented individually or in any combination: an increase in temperature and pressure are controlled to maintain the dendritic ice in a vapor state during the vacuum drying; the electrode particles comprise graphite; the binder is selected from the group consisting of fluoro acrylic polymer, poly tetrafluoro ethylene, poly vinylidene fluoride, poly acrylates, aliphatic polymers, aromatic polymers, oligo- and polysaccharides chitosan, alginate, pectin, amylose, starch, gums, lignin, and proteins; the solvent is selected from the group consisting of H₂O (Water), NMP (N-Methyl-2-pyrrolidone), DMF (Dimethylformamide), DMAC (Dimethylacetamide), and DMSO (Dimethyl sulfoxide); and a temperature and pressure of freezing and drying are adjusted to modify the microstructure of the electrode.

In still another form of the present disclosure, a battery electrode is manufactured by a method comprising: casting a solid battery electrode from a slurry including electrode particles, a binder, and a solvent, wherein residual solvent remains after the casting and the binder remains at least partially elastic; flash-freezing the solid battery electrode such that the residual solvent in the electrode forms dendritic ice having a pattern; and removing the dendritic ice from the solid battery electrode, thereby rearranging the electrode particles and the binder into a microstructure that represents a geometric negative of the pattern of the dendritic ice.

In variations of this battery electrode, which may be implemented individually or in any combination: the dendritic ice is removed by drying; a temperature and pressure of freezing and drying are adjusted to modify the microstructure of the battery electrode; the dendritic ice is removed by vacuum drying; the flash-freezing and vacuum drying are performed in an inert gas environment; and the electrode particles comprise graphite.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flow diagram illustrating a method of manufacturing a battery electrode according to the teachings of the present disclosure; and

FIG. 2 is a photomicrograph of an exemplary dendritic microstructure according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

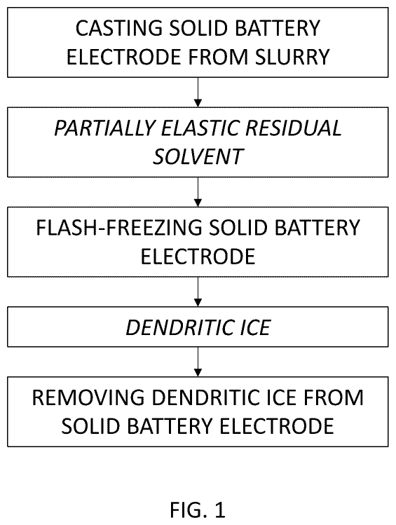

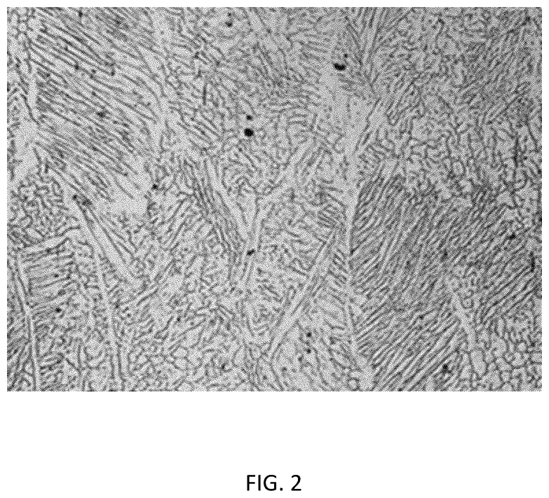

Referring to FIGS. 1 and 2, a process for manufacturing a battery electrode and resulting microstructure of a solid battery electrode are illustrated. As shown, the method generally begins with casting a solid battery electrode from a slurry including electrode particles, a binder, and a solvent.

The electrode particles in one form of the present disclosure are a graphite material. In other forms, the electrode particles are lithium titanate (Li₄Ti₅012), lithium nickel manganese cobalt oxide (NMC111), lithium nickel manganese oxide (NMC532), and graphene, among others. It should be understood that other materials for the electrode particles may be implemented while remaining within the scope of the present disclosure.

The binder may be any of a variety of polymeric materials that function to hold the electrode particles together. For example, the binder may be fluoro acrylic polymer, poly tetrafluoro ethylene, poly vinylidene fluoride, poly acrylates, aliphatic polymers, aromatic polymers, oligo- and polysaccharides chitosan, alginate, pectin, amylose, starch, gums, lignin, and proteins, among others. It should be understood that other materials for the binder may be implemented while remaining within the scope of the present disclosure.

And the solvent generally functions to suspend or disperse the electrode particles and may be any of a variety of materials, including by way of example, H₂O (Water), NMP (N-Methyl-2-pyrrolidone), DMF (Dimethylformamide), DMAC (Dimethylacetamide), and DMSO (Dimethyl sulfoxide), among others. It should be understood that other solvents may be implemented while remaining within the scope of the present disclosure.

After the casting step, residual solvent remains and the binder remains at least partially elastic, which is controlled through the casting parameters (e.g., temperature, pressure, time) as a function of the materials being used (as set forth above) and overall size of the solid battery electrode.

Next, the solid battery electrode undergoes flash-freezing. By way of example, the flash-freezing in one form includes reducing the temperature of the solid battery electrode rapidly using a cold inert gas to sub-zero Celsius temperatures. With this flash-freezing in an inert gas environment, the residual solvent forms dendritic ice (i.e., growing ice crystals) having a pattern, represented in FIG. 2 as a microstructure with a multi-branching, or branching tree-like form.

After the flash-freezing process, the dendritic ice is then removed from the solid battery electrode, which rearranges the electrode particles and the binder into a microstructure that defines a geometric negative of the pattern of the dendritic ice. As used herein, the term “geometric negative” should be construed to mean the negative space, or the void that is formed in the microstructure of the solid battery electrode after the dendritic ice is removed. Advantageously, this dendritic pattern provides distinctive structural characteristics, namely reduced tortuosity and more direct pathways to the electrode surface. This reduced tortuosity provides both faster electrode residual moisture removal as well as improved electrode performance due to the unique structural pattern formed by the dendritic ice.

In one form, the solid battery electrode is placed under vacuum and subjected to infrared radiation, microwaves, or a laser diode, among other focused heat sources, to raise its temperature to remove the dendritic ice. The dendritic ice in another form is removed by drying, which may include vacuum drying. Importantly, the vacuum and temperature rate increase are controlled to maintain the heated dendritic ice in a vapor state during removal. As a result, the structural tortuosity of the solid battery electrode is reduced and more direct pathways to the external surface of the solid battery electrode are produced, thereby allowing for efficient removal of moisture while providing an improved electrode structure.

The precise pattern and shape of the dendritic ice may be adjusted by controlling the time, temperature, and/or pressure of the flash-freezing. For example, with faster times to reach the desired sub-zero Celsius temperature, the dendritic microstructure will have longer branches.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of manufacturing a battery electrode, the method comprising:
casting a solid battery electrode from a slurry including electrode particles, a binder, and a solvent, wherein residual solvent remains after the casting and the binder remains at least partially elastic;
flash-freezing the solid battery electrode such that the residual solvent forms dendritic ice having a pattern; and
removing the dendritic ice from the solid battery electrode, thereby rearranging the electrode particles and the binder into a microstructure that represents a geometric negative of the pattern of the dendritic ice.

2. The method according to claim 1, wherein the dendritic ice is removed by drying.

3. The method according to claim 2, wherein a temperature and pressure during the flash-freezing and the drying are adjusted to modify the microstructure.

4. The method according to claim 2, wherein the dendritic ice is removed by vacuum drying.

5. The method according to claim 4, wherein the flash-freezing and the vacuum drying are performed in an inert gas environment.

6. The method according to claim 1, wherein the electrode particles comprise graphite.

7. The method according to claim 1, wherein the binder is selected from the group consisting of fluoro acrylic polymer, poly tetrafluoro ethylene, poly vinylidene fluoride, poly acrylates, aliphatic polymers, aromatic polymers, oligo- and polysaccharides chitosan, alginate, pectin, amylose, starch, gums, lignin, and proteins.

8. The method according to claim 1, wherein the solvent is selected from the group consisting of H₂O (Water), NMP (N-Methyl-2-pyrrolidone), DMF (Dimethylformamide), DMAC (Dimethylacetamide), and DMSO (Dimethyl sulfoxide).

9. A method of manufacturing an electrode, the method comprising:
casting a solid battery electrode from a slurry including electrode particles, a binder, and a solvent, wherein residual solvent remains after the casting and the binder remains at least partially elastic;
flash-freezing the solid battery electrode in an inert gas environment in a vacuum such that the residual solvent in the electrode forms dendritic ice having a pattern; and
removing the dendritic ice from the solid battery electrode by vacuum drying, thereby rearranging the electrode particles and the binder into a microstructure that represents a geometric negative of the pattern of the dendritic ice.

10. The method according to claim 9, wherein an increase in temperature and pressure are controlled to maintain the dendritic ice in a vapor state during the vacuum drying.

11. The method according to claim 9, wherein the electrode particles comprise graphite.

12. The method according to claim 9, wherein the binder is selected from the group consisting of fluoro acrylic polymer, poly tetrafluoro ethylene, poly vinylidene fluoride, poly acrylates, aliphatic polymers, aromatic polymers, oligo- and polysaccharides chitosan, alginate, pectin, amylose, starch, gums, lignin, and proteins.

13. The method according to claim 9, wherein the solvent is selected from the group consisting of H₂O (Water), NMP (N-Methyl-2-pyrrolidone), DMF (Dimethylformamide), DMAC (Dimethylacetamide), and DMSO (Dimethyl sulfoxide).

14. The method according to claim 9, wherein a temperature and pressure of freezing and drying are adjusted to modify the microstructure of the electrode.

15. A battery electrode manufactured by a method comprising:
casting a solid battery electrode from a slurry including electrode particles, a binder, and a solvent, wherein residual solvent remains after the casting and the binder remains at least partially elastic;
flash-freezing the solid battery electrode such that the residual solvent in the electrode forms dendritic ice having a pattern; and
removing the dendritic ice from the solid battery electrode, thereby rearranging the electrode particles and the binder into a microstructure that represents a geometric negative of the pattern of the dendritic ice.

16. The battery electrode according to claim 15, wherein the dendritic ice is removed by drying.

17. The battery electrode according to claim 16, wherein a temperature and pressure of freezing and drying are adjusted to modify the microstructure of the battery electrode.

18. The battery electrode according to claim 16, wherein the dendritic ice is removed by vacuum drying.

19. The battery electrode according to claim 18, wherein the flash-freezing and vacuum drying are performed in an inert gas environment.

20. The battery electrode according to claim 15, wherein the electrode particles comprise graphite.
